(19) United States
(12) Patent Application Publication
(10) Pub. No.: US 2009/0286026 A1
(43) Pub. Date: Nov. 19, 2009

(54) Digging Blanket for Dogs and Other Domesticated Animals

(76) Inventor: Adrien Lux-Bellus, Vienna (AT)

Correspondence Address: LERNER GREENBERG STEMER LLP, P O BOX 2480, HOLLYWOOD, FL, 33022-2480, US

(21) Appl. No.: 12/464,595

(22) Filed: May 12, 2009

(30) Foreign Application Priority Data
May 13, 2008 (AT) GM 274/2008

(51) Int. Cl. D04H 11/00; D03D 27/00; A01K 29/00

(52) U.S. Cl. 428/35.5; 428/85

(57) ABSTRACT

The digging blanket has a double floor, with an upper part formed with openings and thick dense pile fibers in between the openings. The pile fibers collapse into a pile mound, into which dogs may dig and hide their bones or toys and which therefore allow the dogs to satisfy their natural instincts. The blanket may be tied together by way of a string that is integrated in its margins and that may be pulled to form a type of bag.

### CROSS-REFERENCE TO RELATED APPLICATION

This application claims the priority, under 35 U.S.C. §119, of Austrian application No. GM 274/2008 (Gebrauchsmuster), filed May 13, 2008; the prior application is herewith incorporated by reference in its entirety.

### BACKGROUND OF THE INVENTION

### Field of the Invention

The invention relates to a blanket for dogs and other domestic animals; the blanket supports the natural behavior of dogs and other small animals and enables digging in a domestic environment.

Dogs typically follow their natural behavior to hide food in order to hide the same from other predators and scavengers. This is typically done by digging a hole in the ground and placing the food item into the hole and covering the same with dirt. In a domestic environment, this is either impossible or it causes damage to the yard or even to upholstery inside the domicile and, naturally, often leads to considerable consternation or aggravation on the owners' part. It would be beneficial to provide a solution to this problem, and to enable dogs and other domesticated animals to play out their natural behavior in a domestic environment.

### BRIEF SUMMARY OF THE INVENTION

It is accordingly an object of the invention to provide a digging blanket for dogs and other domestic animals which overcomes the above-mentioned disadvantages of the heretofore-known devices and methods of this general type and which enables dogs and other domesticated animals to follow their digging instincts in a domestic environment.

With the foregoing and other objects in view there is provided, in accordance with the invention, a blanket for a domestic animal, comprising: a blanket substrate having at least one layer of fabric, and pile threads connected to the blanket substrate, the pile threads having a free length configured to collapse into piles or mounds of threads on the blanket substrate.

In accordance with a further feature of the invention, the blanket substrate is formed with openings that allow the animal to hide a toy or a bone. In a preferred embodiment, there are pockets sewn or glued on the bottom, opposite the openings.

In accordance with an added feature of the invention, the blanket substrate is formed of two layers that are connected to one another at their margins and form a space therebetween. The two layers include a lower layer and an upper layer, the upper layer having openings formed therein enabling access to the space between the upper layer and the lower layer, and the pile threads are disposed at an exposed side of the upper layer between the openings.

In accordance with an additional feature of the invention, the pile threads have a free length, measured from a point of attachment at the blanket substrate, of various lengths. For instance, a bulk of the threads may be in the range from 14 cm to 20 cm, with some of the pile threads having a length of up to 40 cm or even more. In accordance with another feature of the invention, the pile threads have a free length of between 10 cm and 14 cm, with some pile threads extending by 20 to 50 cm.

In accordance with a concomitant feature of the invention, there is provided a pull string disposed in the margin and configured to allow the blanket to be pulled together to form a bag.

In sum, the concept disclosed herein is a digging and resting blanket with a double-walled blanket substrate with openings and deep pile fibers.

That is, the objects are satisfied with a digging blanket that is formed with a double floor, wherein the upper part is formed with openings and with thick pile threads in between, which collapse into a thread pile in which the animals may dig and hide bones and the like and which allows them to play out their natural behavior.

In an alternative embodiment, the objects are satisfied with a blanket have very thick, dense pile threads on the blanket substrate, while the blanket itself is not formed with a double floor and also without openings.

The double floor with the openings and the thick, dense, long pile threads, which collapse into a pile, or various piles, allow the animals to dig and hide their bones with their paws and with the nose either through the holes and inside the blanket or only inside the piles (mounds) of pile threads. This, therefore, allows them to act out their natural behavior in a domestic environment, within a small space and without causing damage and dirt. It is also possible for humans to hide objects in the openings in a targeted fashion and thus to prod or train the dogs to search.

It goes without saying that the blanket also serves as a bed for sleeping, since dogs especially often cuddle and dig up the supporting floor for sleeping in a natural environment.

The string that is integrated at the margins of the blanket allows the blanket to be drawn together like a transport bag and also allows the blanket to be washed without exposing the pile threads directly to the harsh washing machine tumbling conditions.

Other features which are considered as characteristic for the invention are set forth in the appended claims.

Although the invention is illustrated and described herein as embodied in a digging blanket for dogs and other domesticated animals, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a perspective view of the blanket according to the invention in a taut condition;

FIG. 2 is a perspective view of the blanket showing several piles of pile threads that have collapsed into piles or mounds;

FIG. 3 is a side view of the blanket with the string pulled to form a soft duffle bag; and

FIG. 4 is a partial side view of a one-layer embodiment of the blanket according to the invention.

### DESCRIPTION OF A PREFERRED EMBODIMENT OF THE INVENTION

Referring now to the figures of the drawing in detail, there is illustrated an exemplary implementation of the invention in the form of a blanket substrate that is formed of two layers, namely, upper layer 1 and a lower layer 2. A space 4 is formed in between the layers 1 and 2. The layers 1, 2 are connected at their margins or edges 7. The upper layer 1 is formed with openings 3 and with thick pile threads 5 in between the openings. The pile threads 5 may cover all or selected parts of the substrate surface between the openings.

In a preferred implementation of the digging blanket, the lower layer 2 is formed of a water-tight material or it has formed thereon a layer that allows the blanket substrate to be watertight on its bottom.

The pile threads 5 collapse into mounds or piles during use, as illustrated in FIG. 2. Animals can dig and hide bones 6 or the like in the pile mounds formed by the threads and thereby play out their natural behavior. For that purpose, the pile thread density and the pile thread length are important parameters. With regard to the length, it is advantageous for the pile threads to have a free length of more than 14 cm (5.5″) in the majority and on average or a free length of between 10 and 14 cm (4″-5.5″) on average or a free length of between 7 and 10 cm (2.8″-4″) on average. Typically, there are additional shag pile threads inserted with a much greater length of, say, 40 to 50 cm (16-20″), or even more. The maximum length of the pile threads and the average length, as well as the density or density distribution, are dictated by the size of the animal for which the digging blanket is provided. For instance, a blanket for a dog with a shoulder height of, say, 50 cm (20″) will preferably be provided with pile threads having a primary length in the range of 20 to 35 cm, with some pile threads or pile thread bundles having a free length of about 40 to 50 cm and some pile threads only amounting to about 10 to 15 cm. As noted, the density and distribution of the pile threads may be freely selected, as long as, on collapsing, the pile threads for at least one, and preferably several, mounds.

The free length is measured from the surface of the upper layer 1 of the blanket and the free length is understood as being a measurement of the pile thread in a stretched or straightened condition.

The blanket layers 1 and 2 may be formed of woven fabric or of non-woven, such as fleece. Especially in the latter case, the openings 3 are formed with a fold and surrounding stabilizing or reinforcement seam.

Quite a similar functionality of the digging blanket is achieved with an embodiment of the invention wherein the blanket substrate is formed with only a single layer, instead of the double layer. The embodiment is illustrated in FIG. 4. The single layer is formed with long pile threads 5 that collapse into piles, which allow a dog, for example, to hide a bone or a toy in the corresponding mound. This single-layer embodiment is advantageous in that less fabric is used for the fabric substrate. FIG. 4 also shows that the pile threads 5 may have different lengths, either in a defined or in an arbitrary distribution.

This is not to say, however, that the single-layer embodiment may not also be provided with openings 3. In that case, there may be provided pockets on the opposite side, as shown in FIG. 4, so that the toy or bone may still be hidden in an opening. The object is then placed, or at least partly placed, in a pocket. The pocket may be sewn onto the bottom surface of the blanket layer 1 and the attachment seam simultaneously functions as a reinforcement seam for the respective opening 3.

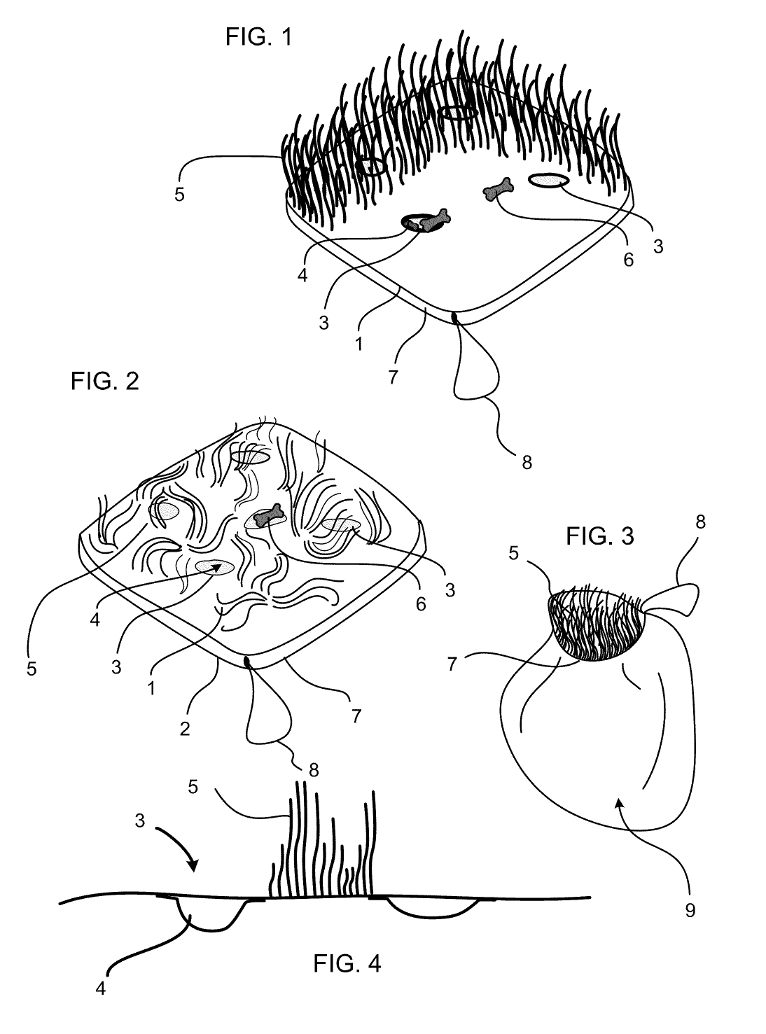

In the embodiment illustrated in FIGS. 1 and 2, where the blanket substrate if formed with two full layers 1 and 2, the two layers may be quilted to one another. In an advantageous implementation, the quilt seams may surround the openings 3, so that, in effect, pockets are formed around the openings 3. This assures that an object that is inserted through an opening 3 is not allowed to freely rove about anywhere within the space 4 between the layers 1 and 2, but that it is confined within a limited pocket.

In the embodiment illustrated in FIGS. 1 and 2, with the two layers and the openings 3 in the top layer, the animal is enabled to hide bones 6 with their paws or their nose in the openings 3 as well as in the mounds formed by the collapsed pile threads 5.

A pull string 8 is incorporated in the margins of the blanket. The pull string 8 allows the blanket to be pulled to form a duffle bag 9, as is illustrated in FIG. 3. This is advantageous for transport, but it is also advantageous when the blanket is to be washed. In that case, the pile thread fibers are disposed inside the folded bag 9 and they are thus protected during the rough tumbling and rinsing cycles in the washer and also in the dryer.

In accordance with a further exemplary embodiment, the blanket may be provided with a strap, for example one or more elastic strap. This is particularly suitable for the embodiment with the one-layer blanket substrate. In that case, the digging blanket according to the invention may be placed directly over an already existing blanket and the straps then hold the digging blanket in place relative to the underlying blanket. In a further variation, a similar effect may also be achieved with hook-and-loop (e.g., Velcro®) connecting strips or pads. Finally, it may also be possible to connect the blankets by way of snap connectors or the like.

While the device according to the invention has been referred to as a blanket or a digging blanket, it may also be referred to as a rug or carpet, a pet rug, or even as a spread or cover.

1. A blanket for a domestic animal, comprising:
a blanket substrate having at least one layer of fabric, and pile threads connected to said blanket substrate, said pile threads having a free length configured to collapse into piles of threads on said blanket substrate.

2. The blanket according to claim 1, wherein said at least one layer of fabric has openings formed therein and pockets attached to a lower side of said layer, wherein said openings enable access into said pockets from an upper side of said layer.

3. The blanket according to claim 1, wherein said at least one layer is one of two layers connected to one another at margins thereof and forming a space therebetween, said two layers including a lower layer and an upper layer, said upper layer having openings formed therein enabling access to said space between said upper layer and said lower layer, and said pile threads are disposed at an exposed side of said upper layer between said openings.

4. The blanket according to claim 3, wherein said lower layer is formed with a water-tight lower surface.

5. The blanket according to claim 1, wherein said pile threads have a free length, measured from a point of attachment at said blanket substrate, with some pile threads having a free length of between 20 cm and 50 cm and some pile threads having a free length of between 10 cm and 20 cm.

6. The blanket according to claim 1, which comprises a pull string disposed in the margin and configured to allow the blanket to be pulled together to form a bag.
